(19) United States
(12) Patent Application Publication
(10) Pub. No.: US 2015/0154401 A1
(43) Pub. Date: Jun. 4, 2015

(54) COMPUTING DEVICE AND METHOD FOR BOOTING THE COMPUTING DEVICE

(71) Applicants: HON HAI PRECISION INDUSTRY CO., LTD., NEW TAIPEI (TW); HONG FU JIN PRECISION INDUSTRY (WUHAN) CO., LTD., WUHAN (CN)

(72) Inventors: MIN YANG, Wuhan (CN); XIN-SHU WANG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/141,461

(22) Filed: Dec. 27, 2013

(30) Foreign Application Priority Data
Nov. 29, 2013 (CN) 2013106281502

(51) Int. Cl. G06F 21/57

(52) U.S. Cl. CPC G06F 21/575

(57) ABSTRACT

In a method of booting a computing device, the computing device includes a system disk and an embedded controller. The computing device removes a master boot record (MBR) and a disk partition table (DPT) from a master boot sector to a hidden sector of the system disk. The computing device installs a predetermined verification program in the master boot sector, and executes the verification program. Once the verification program receives a predetermined identification code from the embedded controller, the computing device is booted by the verification program according to the MBR and DPT in the hidden sector.

### BACKGROUND

1. Technical Field

Embodiments of the present disclosure relates to a computing device and a method for booting the computing device.

2. Description of Related Art

A computing device (e.g., a personal computer) may include private and confidential files. However, the private and confidential files may be divulged if the computing device is booted and accessed by an illegal user. Therefore, what is needed, is a computing device and a method for booting the computing device, to increase security of the private and confidential files.

### BRIEF DESCRIPTION OF THE DRAWINGS

FIG. 1 is a block diagram of one embodiment of a computing device including a booting system.

FIG. 2 is a flowchart of one embodiment of a method for booting the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

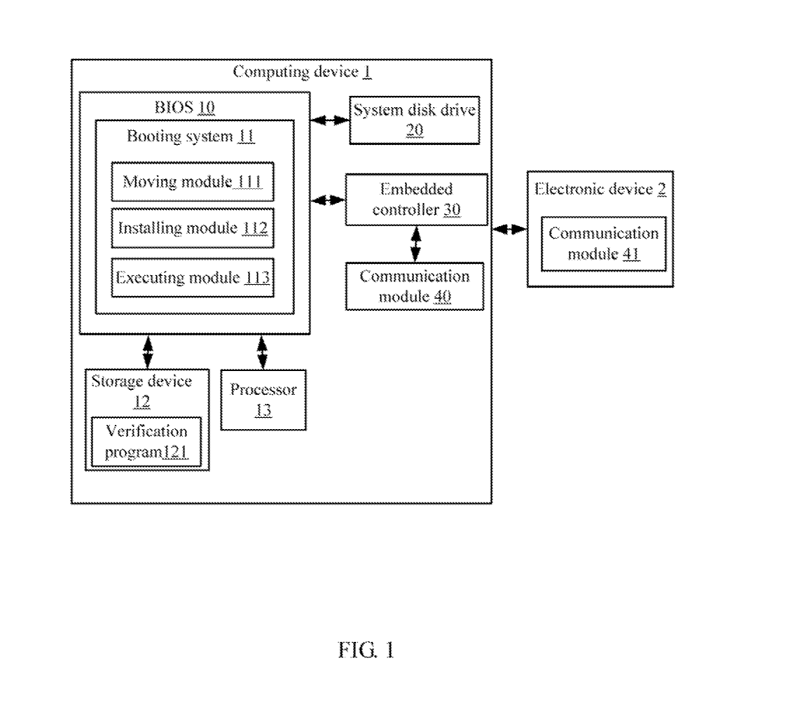

FIG. 1 is a block diagram of one embodiment of a computing device 1. The computing device 1 may be a personal computer or other device (e.g., a server). In this embodiment, the computing device 1 includes a basic input-output system (BIOS) 10, a system disk drive 20, an embedded controller 30, a communication module 40, a storage device 12, and at least one processor 13.

The BIOS 10 includes a booting system 11. The storage device 12 stores a verification program 121 that is pre-programmed by a user. The system disk drive 20 includes a master boot sector and a hidden sector. The master boot sector stores a master boot record (MBR) and a disk partition table (DPT), which are used to boot the computing device 1.

In this embodiment, the booting system 11 obtains the MBR and the DPT from the master boot sector, and stores the MBR and the DPT into the hidden sector, when the computing device 1 initializes the system disk drive 20. The booting system 11 further deletes the MBR and the DPT from the master boot sector when the MBR and the DPT are stored in the hidden sector.

In this embodiment, the booting system 11 further installs the verification program 121 in the master boot sector and executes the verification program 121 to boot the computing device 1 according to the MBR and DPT in the hidden sector.

In one embodiment, the verification program 121 boots the computing device 1 according to the MBR and DPT in the hidden sector, only when a predetermined identification code is received from the embedded controller 30.

In this embodiment, the predetermined identification code is an International Mobile Equipment Identity (IMEI) or a media access control address of an electronic device 2, which communicates with the computing device 1. In one embodiment, the electronic device 2 may be a mobile phone or a tablet personal computer.

In this embodiment, the electronic device 2 communicates with the computing device 1 through a communication module 41 of the electronic device 2 and the communication module 40 of the computing device 1. The communication modules 40, 41 may be BLUETOOTH modules or near field communication (NFC) modules.

It should be emphasized that, to ensure that the embedded controller 30 can obtain the predetermined identification code from the electronic device 2 using the communication module 40, before the computing device 1 is booted. A circuit (not indicated) of a motherboard of the computing device 1 is designed to supply power to the embedded controller 30 and the communication module 40, when the computing device 1 is in a power-on status.

In this embodiment, the booting system 10 may include a moving module 111, an installing module 112, and en executing module 113. The modules 111-113 includes computerized codes in the form of one or more programs that may be stored in the storage device 12. The computerized codes include instructions that are executed by the processor 13.

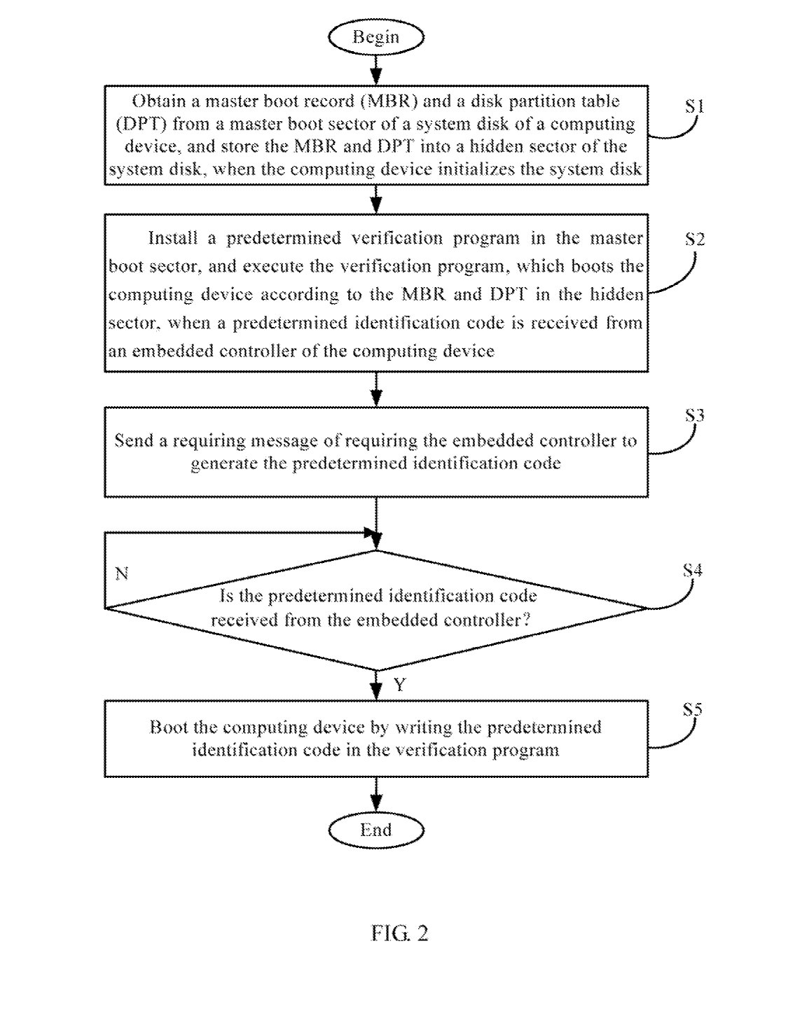

FIG. 2 is a flowchart of one embodiment of a method of booting the computing device 1. Depending on the embodiments, additional steps may be added, others deleted, and the ordering of the steps may be changed.

In step S1, the moving module 111 obtains the MBR and the DPT from the master boot sector, and stores the MBR and the DPT into the hidden sector of the system disk drive 20, when the computing device 1 initializes the system disk drive 20.

In the embodiment, the moving module 111 further deletes the MBR and the DPT from the master boot sector when the MBR and the DPT are stored in the hidden sector. That is, after the step S1 is processed, the computing device 1 can not be booted according to the MBR and the DPT in the master boot sector, since the MBR and the DPT are deleted from the master boot sector.

In step S2, the installing module 112 installs the verification program 121 in the master boot sector, when the MBR and the DPT are stored into the hidden sector. The installing module 112 further executes the verification program 121 when the verification program 121 is successfully installed in the master boot sector.

In one embodiment, the verification program 121 boots the computing device 1 according to the MBR and the DPT in the hidden sector, only when a predetermined identification code is received from the embedded controller 30. In other words, the verification program 121 does not boot the computer device 1 before the predetermined identification code is received.

That is, after the step S2 is processed, a user who wants to use the computing device 1, the user needs to have the verification program 121 receive the predetermined identification code.

In step S3, the executing module 113 sends the requiring message of requiring the embedded controller 30 to generate the predetermined identification code.

In one embodiment, when the embedded controller 30 receives the requiring message, the embedded controller 30 obtains an input identification code from the electronic device 1, and sends the predetermined identification code to the executing module 13 when the input identification code is equal to the predetermined identification code.

In step S4, the executing module 113 determines whether the predetermined identification code is received from the embedded controller 30. If the predetermined identification code is received from the embedded controller 30, the process goes to step S5. Otherwise, step S4 is repeated until the predetermined identification code is received from the embedded controller 30.

In step S5, the executing module 113 boots the computing device 1 by writing the predetermined identification code in the verification program 121.

As mentioned above, the verification program 121 boots the computing device 1 according to the MBR and DPT in the hidden sector, only when the predetermined identification code is received. That is, when the executing module 113 writes the predetermined identification code in the verification program 121, the verification program 121 receives the predetermined identification code, then the computing device 1 is booted by the verification program 121.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a system disk drive comprising a master boot sector that stores a master boot record (MBR) and a disk partition table (DPT) of the computing device:
an embedded controller;
at least one processor; and
a storage device that stores a computer-readable program including instructions, which when executed by the processor, causes the processor to:
obtain the MBR and the DPT from the master boot sector and store the MBR and the DPT into a hidden sector of the system disk drive, when the system disk drive is initialized;
delete the MBR and the DPT from the master boot sector, when the MBR and the DPT are stored into the hidden sector;
install a predetermined verification program in the master boot sector, and execute the verification program, wherein the verification program boots the computing device according to the MBR and the DPT in the hidden sector, when the verification program receives a predetermined identification code from the embedded controller;
send a requiring message of requiring the embedded controller to generate the predetermined identification code; and
boot the computing device by writing the predetermined identification code in the verification program, when the predetermined identification code is received from the embedded controller.

2. The computing device of claim 1, wherein the embedded controller generates the predetermined identification code by steps of:
obtaining an input identification code from an electronic device communicating with the computing device, when the requiring message is received; and
sending the predetermined identification code to the processor when the input identification code is equal to the predetermined identification code.

3. The computing device of claim 2, wherein the electronic device communicates with the computing device through a BLUETOOTH module or a near field communication (NFC) module.

4. The computing device of claim 2, wherein the predetermined identification code is an International Mobile Equipment Identity (IMEI) or a media access control address of the electronic device.

5. A method for booting a computing device, the computing device comprising a system disk drive, the system disk drive comprising a master boot sector that stores a master boot record (MBR) and a disk partition table (DPT) of the computing device, the computing device further comprising an embedded controller, the method comprising:
obtaining the MBR and the DPT from the master boot sector and storing the MBR and the DPT into a hidden sector of the system disk drive, when the system disk drive is initialized;
deleting the MBR and the DPT from the master boot sector, when the MBR and the DPT are stored into the hidden sector;
installing a predetermined verification program in the master boot sector, and executing the verification program, wherein the verification program boots the computing device according to the MBR and the DPT in the hidden sector, when the verification program receives a predetermined identification code from the embedded controller;
sending a requiring message of requiring the embedded controller to generate the predetermined identification code; and
booting the computing device by writing the predetermined identification code in the verification program, when the predetermined identification code is received from the embedded controller.

6. The method of claim 5, wherein the embedded controller generates the predetermined identification code by steps of:
obtaining an input identification code from an electronic device communicating with the computing device, when the requiring message is received; and
sending the predetermined identification code to the processor when the input identification code is equal to the predetermined identification code.

7. The method e of claim 6, wherein the electronic device communicates with the computing device through a BLUETOOTH module or a near field communication (NFC) module.

8. The method of claim 6, wherein the predetermined identification code is an International Mobile Equipment Identity (IMEI) or a media access control address of the electronic device.

9. A non-transitory storage medium having stored thereon instructions that, when executed by a processor of a computing device, causes the processor to perform a method for booting the computing device, the computing device comprising a system disk, the system disk comprising a master boot sector that stores a master boot record (MBR) and a disk partition table (DPT) of the computing device, the computing device further comprising an embedded controller, the method comprising:
obtaining the MBR and the DPT from the master boot sector and storing the MBR and the DPT into a hidden sector of the system disk drive, when the system disk drive is initialized;
deleting the MBR and the DPT from the master boot sector, when the MBR and the DPT are stored into the hidden sector;
installing a predetermined verification program in the master boot sector, and executing the verification program, wherein the verification program boots the computing device according to the MBR and the DPT in the hidden sector, when the verification program receives a predetermined identification code from the embedded controller;
sending a requiring message of requiring the embedded controller to generate the predetermined identification code; and
booting the computing device by writing the predetermined identification code in the verification program, when the predetermined identification code is received from the embedded controller.

10. The non-transitory storage medium of claim 9, wherein the embedded controller generates the predetermined identification code by steps of:
obtaining an input identification code from an electronic device communicating with the computing device, when the requiring message is received; and
sending the predetermined identification code to the processor when the input identification code is equal to the predetermined identification code.

11. The non-transitory storage medium of claim 10, wherein the electronic device communicates with the computing device through a BLUETOOTH module or a near field communication (NFC) module.

12. The non-transitory storage medium of claim 10, wherein the predetermined identification code is an International Mobile Equipment Identity (IMEI) or a media access control address of the electronic device.
